(19) United States
(12) Patent Application Publication
(10) Pub. No.: US 2024/0393464 A1
(43) Pub. Date: Nov. 28, 2024

(54) SAMPLING DATA PROCESSING METHOD AND PRODUCT FOR LIDAR

(71) Applicant: SUTENG INNOVATION TECHNOLOGY CO., LTD., Shenzhen (CN)

(72) Inventor: Yan ZHAO, Shenzhen (CN)

(73) Assignee: SUTENG INNOVATION TECHNOLOGY CO., LTD., Shenzhen (CN)

(21) Appl. No.: 18/625,201

(22) Filed: Apr. 3, 2024

(30) Foreign Application Priority Data
May 26, 2023 (CN) 202310614915.0

(51) Int. Cl. G01S 17/89; G01S 7/497

(52) U.S. Cl. CPC G01S 17/89; G01S 7/497

(57) ABSTRACT

Embodiments of this application provides a sampling data processing method and related products for a LiDAR, including: sampling an echo to obtain sampling data; processing the sampling data sequentially to obtain point cloud data; inputting the point cloud data into the cache of the digital center module for storage; reading the point cloud data from the cache and generating at least one frame of point cloud data based on the point cloud data; fetching data from the module to be analyzed to obtain fetched data; switching the digital center module to input the fetched data into the cache of the digital center module for storage; and reading the fetched data from the cache and performing fault analysis based on the fetched data.

### CROSS-REFERENCE TO RELATED APPLICATION

The present application claims the benefit of priority to Chinese Patent Application No. 202310614915.0, filed on May 26, 2023, which is hereby incorporated by reference in its entirety.

### TECHNICAL FIELD

This application relates to the field of experimental equipment, particularly to a sampling data processing method and product for a LiDAR.

### TECHNICAL BACKGROUND

A LIDAR is an active remote sensing device that uses optoelectronic technology for detection, which combines optoelectronic detection technology with laser technology, making it an advanced detection method that uses a laser as the detection light source. The LiDAR includes transmission modules, scanning modules, reception modules, data processing modules, etc. The transmission module emits detection signals to the target. The scanning module changes the emission direction of the detection signal. The reception module samples the echo signal of the detection signal. The data processing module processes the echo signal to obtain information such as the distance, reflectivity, speed, and size of the detected target.

In the LiDAR, the sampling data from the reception module is processed by the data processing module to obtain the initial point cloud data. Before that, it will go through multiple intermediate processing modules for preprocessing, and then enter the data processing module for processing. The data before the sampling data is converted into the initial point cloud data, also known as intermediate data. The logic of different intermediate processing modules varies, some do not require a data buffer, some only require a small dat_buffer, and some require a larger cache buffer.

Due to the insufficient maturity of the preprocessing process and modules, it is necessary to capture some intermediate data from each preprocessing module for analysis to troubleshoot each preprocessing module. However, the interfaces between the preprocessing modules are different, and the data formats and amounts vary. It is a challenge to ensure that data from each module can be captured. Related arts typically add a dat_buffer to each intermediate processing module to store intermediate data, and use a set of buses connected to each intermediate processing module to capture the intermediate data from the dat_buffer of each intermediate processing module. In order to adapt to the format of the buses, it is often necessary to make adjustments to the original intermediate processing module. Moreover, due to the fact that the intermediate data is pre compressed, the total data volume can sometimes reach hundreds of times that of the initial point cloud data, resulting in a particularly high consumption of storage resources.

### SUMMARY

Embodiments of this application provides a sampling data processing method and product for a LiDAR, which can save the internal storage resource overhead of the LiDAR.

In an embodiment, a sampling data processing method for LiDAR is provided, where the LiDAR includes a sampling module, at least two intermediate processing modules, a digital center module, and a framing module. The method includes:
sampling an echo through the sampling module to obtain sampling data;
processing the sampling data sequentially through the at least two intermediate processing modules, to obtain point cloud data. Each intermediate processing module processes data from an upstream module to obtain intermediate data and outputs the intermediate data to a downstream module; inputting the point cloud data into a cache of the digital center module for storage; reading the point cloud data from the cache through the framing module, and generating at least one frame of point cloud data based on the point cloud data;
when a module to be analyzed is determined from the at least two intermediate processing modules, fetching data from the module to be analyzed to obtain fetched data;
switching the digital center module to input the fetched data into the cache of the digital center module for storage; and
reading the fetched data from the cache through the framing module, and performing fault analysis on the module to be analyzed based on the fetched data.

In an embodiment, when the module to be analyzed is determined from the at least two intermediate processing modules, the method further includes:
controlling an intermediate processing module downstream of the module to be analyzed to enter a bypass mode; and
directly passing the fetched data to the digital center module through the intermediate processing module that enters the bypass mode.

In an embodiment, the at least two intermediate processing modules are connected to the digital center module through a group of buses respectively; and the fetched data is inputted into the digital center module through a bus between the module to be analyzed and the digital center module.

In an embodiment, the LiDAR has a working mode and a detection mode. In the working mode, the method further includes processing the sampling data sequentially through the at least two intermediate processing modules, to obtain point cloud data, and inputting the point cloud data into a cache of the digital center module for storage. In the detection mode, the method further includes determining the module to be analyzed from the at least two intermediate processing modules.

In an embodiment, the sampling module includes multiple pixels, and the sampling data includes pixel data obtained by sampling at least some of the pixels. When the module to be analyzed is determined from the at least two intermediate processing modules, before fetching data from the module to be analyzed, the method further includes: reading pixel data in different regions of the sampling module in a plurality of times, where the pixel data read at one time is processed by the module to be analyzed; and after the fetched data of the module to be analyzed is stored in the cache of the digital center module, a next reading starts.

In an embodiment, when the fetched data corresponding to the pixel data read at one time is stored in the cache of the digital center module, the fetched data corresponding to the pixel data read in the last time is overwritten in the cache.

In an embodiment, inputting the point cloud data into the cache of the digital center module for storage includes:
sequentially storing point cloud data corresponding to the sampling data obtained through the sampling module in the cache of the digital center module in an order of sampling by the sampling module,
where point cloud data on the same row in one frame of point cloud data is stored at adjacent storage addresses in the cache, so that the framing module to read the point cloud data in the cache in a row-wise order, and a maximum pitch angle and a minimum pitch angle of point cloud data on the same row in one frame of point cloud data differ by less than a first preset angle.

In an embodiment, the point cloud data includes distance data and reflectivity data. The cache of the digital center module partitions and stores the distance data and the reflectivity data separately, where the distance data on the same row in one frame of point cloud data is stored at adjacent storage addresses in the cache, and the reflectivity data on the same row in one frame of point cloud data is stored at adjacent storage addresses in the cache.

In an embodiment, before the module to be analyzed is determined from the at least two intermediate processing modules, the cache of the digital center module is released and divided into at least two regions. Switching the digital center module to input the fetched data into the cache of the digital center module for storage includes: storing the fetched data in at least two regions of the cache of the digital center module through a ping-pong operation.

In an embodiment, a sampling data processing device is provided, including a sampling module, at least two intermediate processing modules, a digital center module, a framing module, and a fetching module, where the sampling module is configured to samples an echo to obtain sampling data; the at least two intermediate processing modules are configured to process the sampling data sequentially to obtain point cloud data; each intermediate processing module is configured to processes data from an upstream module to obtain intermediate data and outputs it to a downstream module; the digital center module is configured to input the point cloud data into the cache of the digital center module for storage;
the framing modules is configured to read the point cloud data from the cache and generates at least one frame of point cloud data based on the point cloud data;
the fetching module is configured to, when the module to be analyzed is determined from the at least two intermediate processing modules, fetches data from the module to be analyzed to obtain fetched data; the digital center module is further configured to switches to input the fetched data into the cache of the digital center module for storage; the framing module is further configured to read the fetched data from the cache and performs fault analysis on the module to be analyzed based on the fetched data.

In an embodiment, a LiDAR is provided, including: a processor; and a storage medium storing executable code, where when the executable code is executed by the processor, the processor performs any of the methods as described.

In an embodiment, a computer-readable storage medium is provided, where the computer-readable storage medium stores executable code, and when the executable code is executed by a processor of LiDAR, the LiDAR performs any of the methods as described.

In the embodiments of this application, when it is necessary to fetch intermediate processing data from intermediate processing modules for fault analysis of the modules, different intermediate processing data from different modules are stored in the cache of the digital center module at different times, allowing the point cloud data and the intermediate data from different modules to share the cache of the digital center module at different times, which can save the internal storage resource overhead of the LiDAR.

### BRIEF DESCRIPTION OF DRAWINGS

FIG. 1 illustrates a schematic diagram of a LiDAR, according to some embodiments;

FIG. 2 illustrates a schematic diagram of a sampling data processing method for the LiDAR shown in FIG. 1, according to some embodiments;

FIG. 3 illustrates a partial structural schematic diagram of the LiDAR, according to some embodiments;

FIG. 4 illustrates a schematic diagram of reading data from adjacent reception blocks, according to some embodiments;

FIG. 5 illustrates a schematic diagram of storing the point cloud data in the cache region of the digital center module, according to some embodiments;

FIG. 6 illustrates a schematic diagram of storing the fetched data in the cache region of the digital center module through a ping-pong operation, according to some embodiments;

FIG. 7 illustrates a schematic diagram of a sampling data processing device, according to some embodiments; and

FIG. 8 illustrates a schematic diagram of the LiDAR, according to some embodiments.

### DETAILED DESCRIPTION

The singular forms “a,” “an,” and “the” used in embodiments of this application and the appended claims are also intended to encompass plural forms unless the context clearly indicates otherwise. The term “and/or” used herein refers to any or all possible combinations of one or more of the associated listed items.

Terms such as “first,” “second,” “third,” etc., may be used to describe various information in embodiments. These terms are only used to distinguish the same type of information from each other. For example, without departing from the scope of this application, the first information can also be referred to as the second information, and similarly, the second information can also be referred to as the first information. Therefore, features designated as “first,” “second,” may explicitly or implicitly include one or more of that feature. In the description of this application, the meaning of “multiple” is two or more, unless otherwise defined.

A LIDAR is a radar system that detects the position, velocity, and other characteristics of targets by emitting laser beams. The working principle involves sequentially emitting multiple laser beams by using a laser emitter, which, when encountering objects, get reflected and are received by a receiver as echoes. The LiDAR can be mechanical, semi-solid-state, or solid-state. The LiDAR calculates the time difference between receiving the reflected echo and emitting the laser beam, which represents the flight time of the laser beam. Based on this flight time, the LiDAR calculates parameters such as the distance and azimuth of the object reflecting the echo, as well as the reflectivity based on the energy of the echo and the energy of the emitted laser beam, enabling environmental detection.

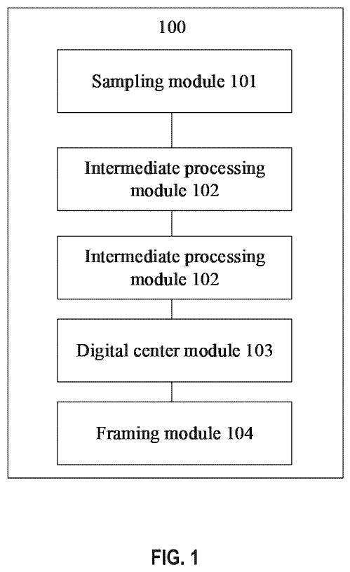

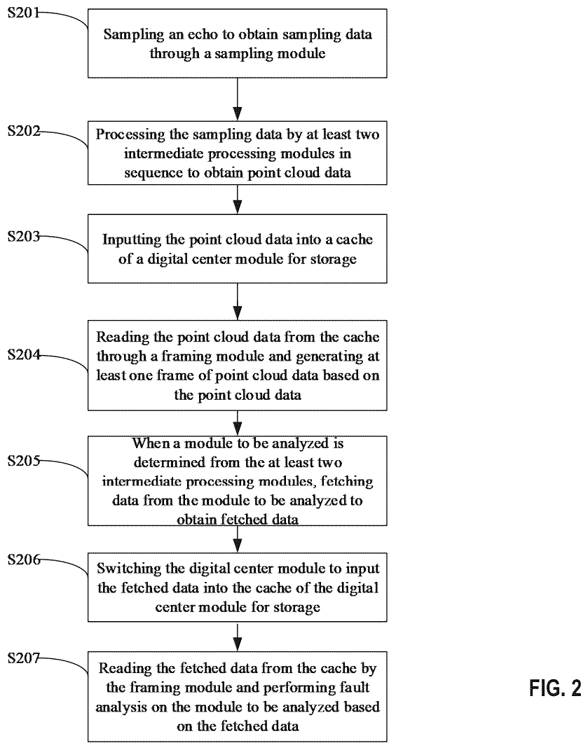

FIG. 1 illustrates a schematic diagram of a LiDAR, according to some embodiments. FIG. 2 illustrates a schematic diagram of a sampling data processing method for the LiDAR shown in FIG. 1, according to some embodiments.

In an embodiment, as shown in FIG. 1, the LiDAR 100 includes a sampling module 101, at least two intermediate processing modules 102, a digital center module 103, and a framing module 104. In an embodiment, FIG. 1 illustrates that the LiDAR 100 has three intermediate processing modules 102. In some embodiments, a quantity of these intermediate processing modules 103 can be two, four, or other numbers.

In an embodiment, the LiDAR further includes an emitting module 105 for emitting a laser beam, converting the electrical signal into an optical signal for emitting. A sampling module 101 is used to receive the reflected echo of the emitted laser beam from objects and convert the echo into an electrical signal. At least two intermediate processing modules 102 are used to process the electrical signals from the sampling module 101 sequentially, where each intermediate processing module processes data from an upstream module to obtain intermediate data and then outputs it to a downstream module. The last intermediate processing module 102 is used for storing the processed point cloud data in the cache of the digital center module 103. Each intermediate processing module is used to calculate at least one of the following intermediate data based on the echo corresponding to the sampling signal: distance, azimuth, and reflectivity. The intermediate data is stored as point cloud data by the last intermediate processing module 102 in the cache of the digital center module 103, where each point cloud data point in the point cloud data is used to represent the object reflecting the echo.

The framing module 104 is used to read point cloud data from the cache region of the digital center module 103, and to generate at least one frame of point cloud based on the multiple point cloud data read. In an embodiment, the framing module 104 can be implemented through an Image Signal Processing (ISP) or a Microcontroller Unit (MCU). In one example, the framing module 104 is used to form a frame of point cloud by collecting point cloud data over a continuous period of time. In an embodiment, the duration of each frame of point cloud output by the LiDAR is the same, meaning that the point cloud collected within a fixed period is output as one frame of point cloud. In an embodiment, point cloud frames can also be output at variable frequencies. The at least one frame of point cloud formed by the framing module 104 can be used for additional recognition and perception of the external environment.

In an embodiment, the LiDAR may also include a scanning module (such as MEMS mirrors) to change the emission direction of the laser beam emitted, enabling the laser beam to scan within a certain field of view. The reflected echoes and the outgoing laser can have coaxial optical paths, where the reflected echoes return along the same path through the scanning module-transceiver module and are received by the receiver in the transceiver module. The LiDAR can implement a single-channel scan or can implement multi-channel simultaneous or interleaved scanning. In the case of multi-channel scanning, it can be implemented through multiple groups of transceiver modules, where the optical paths (outgoing laser and reflected echoes) between each channel are isolated from each other.

In an embodiment, the sampling module includes multiple pixels, where each pixel is used to sample echoes from different directions, and the sampling data includes pixel data obtained through at least some of the pixels. In an embodiment, the multiple pixels form different receiver blocks. For example, each receiver block contains a pixel array, such as a 4*8 pixel array. All receiver blocks in the sampling module can work simultaneously, or they can work in a time-division or partial simultaneous manner. For example, when a LiDAR emits a laser beam once, some receiver blocks sample the echoes, and in the next laser beam emission, another group of receiver blocks samples the echoes. The groups of receiver blocks opened in two consecutive emissions can be completely different or partially overlapping.

As shown in FIG. 2, the sampling data processing method 200 of the LiDAR includes:

Step S201, sampling an echo to obtain sampling data through a sampling module.

Step S202, processing the sampling data by at least two intermediate processing modules in sequence to obtain point cloud data.

Each intermediate processing module processes data from an upstream module to obtain intermediate data and outputs it to a downstream module.

Step S203, inputting the point cloud data into a cache of a digital center module for storage.

Step S204, reading the point cloud data from the cache through a framing module and generates at least one frame of point cloud data based on the point cloud data.

Step S205, when a module to be analyzed is determined from the at least two intermediate processing modules, fetching data from the module to be analyzed to obtain fetched data.

For the possibility of faults in the intermediate processing modules, after the module to be analyzed is determined from the intermediate processing modules, data can be fetched from this module, and fault analysis can be performed on the module based on the fetched data. Data can be fetched from at least some different intermediate processing modules at different times. For example, each intermediate processing module of the at least two intermediate processing modules can be sequentially determined as the module to be analyzed, or alternatively, some intermediate processing modules of the at least two intermediate processing modules can be sequentially determined as the module to be analyzed. In the case where the number of intermediate processing modules is greater than 2, in an embodiment, two intermediate processing modules can also be simultaneously determined as the module to be analyzed and data can be fetched from both at the same time.

Step S206, switching the digital center module to input the fetched data into the cache of the digital center module for storage.

The digital center module has two groups of input links, where the first group of input links is used to input point cloud data in step S203 to the cache of the digital center module, and the second group of input links is used to input the fetched data in step S205 to the cache of the digital center module. The cache is used to store input data from one of the two groups of input links during the same period. One group of input links can be selected via MUX to input data to the cache of the digital center module for storage.

When fetching data in step S205 by selecting inputs through MUX, the fetched data captured at different time periods is stored in different time periods in the cache region of the digital center module, to reduce the bandwidth and storage resources consumed by the fetched data. There are various methods for transferring the fetched data from the corresponding module to be analyzed to the cache region of the digital center module. In one example, the at least two intermediate processing modules are connected to the digital center module through a group of buses respectively; and the fetched data is inputted into the digital center module through a bus between the module to be analyzed and the digital center module. In one example, when the module to be analyzed is determined from the at least two intermediate processing modules, before step S206, it controls the intermediate processing module downstream of the module to be analyzed to enter a bypass mode; the fetched data is directly passed to the digital center module through the intermediate processing module that enters the bypass mode for storage in the cache region of the digital center module. Compared to the example where each intermediate processing module is respectively connected to the digital center module through a group of buses, the example where the fetched data from the module to be analyzed is directly passed to the digital center module through the intermediate processing module downstream of the module to be analyzed, it can avoid problems such as excessive interface connections and excessively long paths.

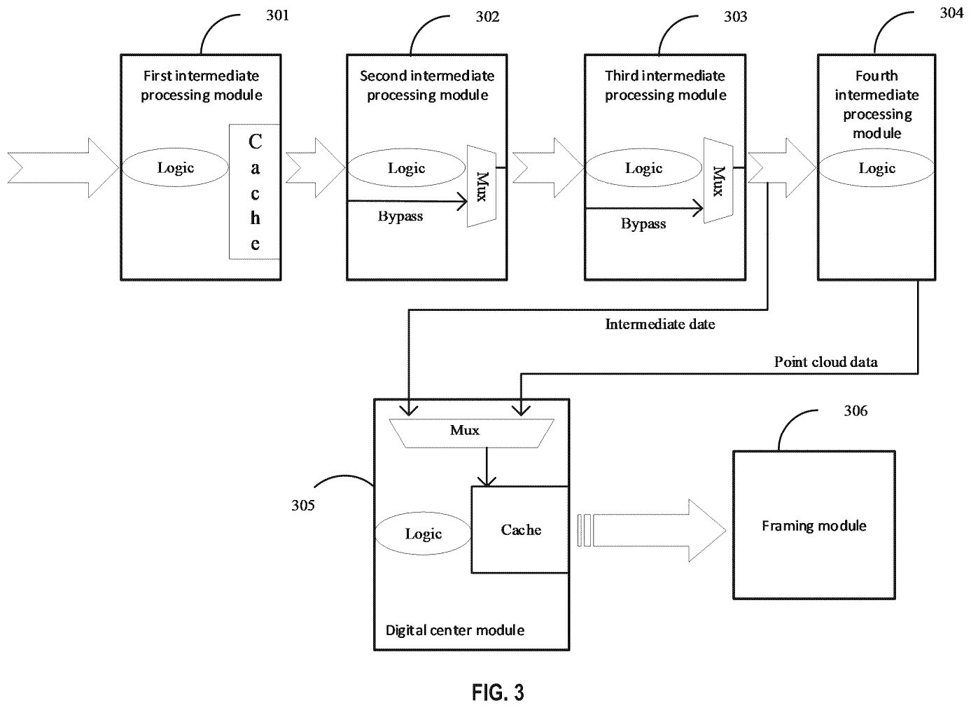

FIG. 3 illustrates a partial structural schematic diagram of the LiDAR, according to some embodiments.

In an embodiment, as shown in FIG. 3, the LiDAR 300 includes a first intermediate processing module 301, a second intermediate processing module 302, a third intermediate processing module 303, a fourth intermediate processing module 304, a digital center module 305, and a framing module 306. When the first intermediate processing module 301 is determined as the module to be analyzed, control is applied to group the second intermediate processing module 302, the third intermediate processing module 303, and the fourth intermediate processing module 304 downstream of the first intermediate processing module 301 to enter a bypass mode. In an embodiment, at least one intermediate processing module connected to the digital center module 305 may also not enter the bypass mode, and the intermediate data is directly passed to the digital center module 305 by the last intermediate processing module entering the bypass mode in the data link. As shown in FIG. 3, the fourth intermediate processing module 304 connected to the digital center module 305 may also not enter the bypass mode, and the intermediate data is directly passed to the digital center module 305 by the third intermediate processing module 303.

The second intermediate processing module 302 and the third intermediate processing module 303 each have two groups of input links. The first group of input links is used to receive intermediate data from the upstream module for processing and then input the processed intermediate data to the downstream module. The second group of input links is used to receive intermediate data from the upstream module and pass it directly to the downstream module. After controlling the second intermediate processing module 302 and the third intermediate processing module 303 to enter the bypass mode, the data fetched from the first intermediate processing module 301 is selected by MUX and sequentially passed through the second group of input links of the second intermediate processing module 302, the third intermediate processing module 303, and the digital center module 305 to be stored in the cache of the digital center module 305.

Step S207, reading the fetched data from the cache by the framing module, and performing fault analysis on the module to be analyzed based on the fetched data.

After the framing module stores the fetched data of each analyzed module in the cache of the digital center module, it reads the fetched data from the cache for analysis. For example, compared with calibration data, or analyzed through preset algorithms to determine if the analyzed module has any faults and/or the specific fault location.

In the embodiments of this application, when it is necessary to fetch intermediate data from intermediate processing modules for fault analysis of the modules, different intermediate data from different intermediate processing modules is fetched at different time intervals. This allows the intermediate data from different intermediate processing modules to be stored in the cache of the digital center module in a time-sharing manner, enabling the sharing of the cache region of the digital center module between point cloud data and intermediate data from different intermediate processing modules at different time intervals, thereby saving storage resource overhead within the LiDAR.

In an embodiment, where the sampling module includes multiple pixels, when the module to be analyzed is determined from the at least two intermediate processing modules, before fetching data from the module to be analyzed, the sampling data processing method further includes: reading pixel data in different regions of the sampling module for multiple times, where the pixel data read in one instance is processed by the module to be analyzed, and after the fetched data of the module to be analyzed is stored in the cache of the digital center module, the next reading cycle begins. The module to be analyzed does not need to process all the pixel data generated by one echo at once, but processes the pixel data generated by one echo in batches. When fetching data from the module to be analyzed, the fetched data corresponds to the intermediate data obtained from processing the pixel data read in this instance, rather than the intermediate data obtained from processing the pixel data of all pixels generating sampling data for one echo, which can reduce the amount of data fetched each time, thereby reducing the bandwidth and storage resources occupied by the fetched data.

In an embodiment, when the fetched data corresponding to the pixel data read in one time is stored in the cache of the digital center module, the fetched data corresponding to the pixel data read in the last time is covered in the cache, which can further reduce the storage resources occupied by the fetched data.

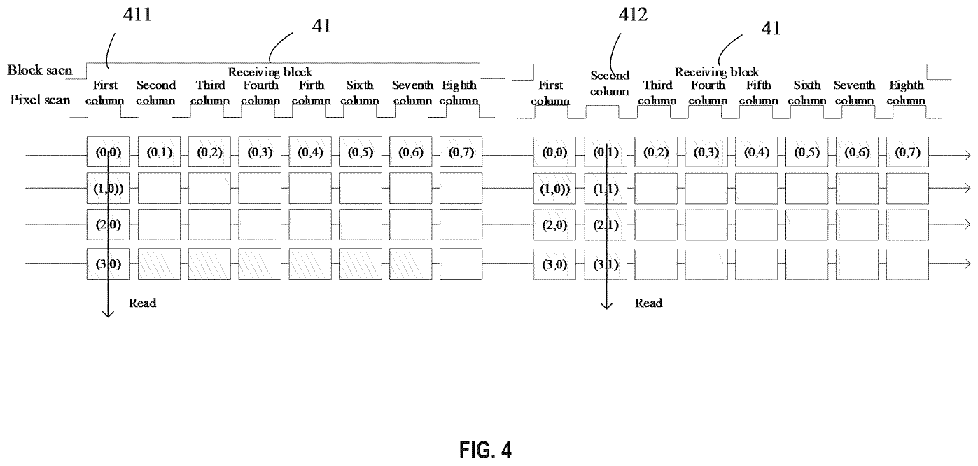

FIG. 4 illustrates a schematic diagram of reading data from adjacent reception blocks, according to some embodiments.

In an embodiment as shown in FIG. 4, taking three receiver blocks for receiving each echo as an example, each receiver block containing 4 rows and 8 columns of pixels as shown in FIG. 4. When reading data from the receiver block to input into the first intermediate processing module, the pixel data of 4 pixels in the first column 411 of the first receiver block 41 is first read. This pixel data of the 4 pixels is processed by the module to be analyzed, and after the fetched data of the module to be analyzed is stored in the cache region of the digital center module, the pixel data of 4 pixels in the second column 412 of the first receiver block 41 is then read. In an embodiment, when the fetched data corresponding to the pixel data of the 4 pixels in the second column 412 is stored in the cache region of the digital center module, the fetched data corresponding to the pixel data of the 4 pixels in the first column 411 in the cache region is overwritten.

Sequentially, until all pixel data in the first reception block 41 is read, then switch to read the pixel data of 4 pixels in the first column of the second reception block of the three reception blocks used to receive the current echo. This process continues until all pixel data of these three reception blocks are read.

In an embodiment, the cache region of the digital center module, when storing point cloud data or when storing fetched data, can be stored in a modularized manner to meet different storage requirements.

In some embodiments, the point cloud data includes distance data and reflectivity data. The cache of the digital center module partitions and stores the distance data and the reflectivity data separately, where the distance data on the same row in one frame of point cloud data is stored at adjacent storage addresses in the cache, and the reflectivity data on the same row in one frame of point cloud data is stored at adjacent storage addresses in the cache.

In some embodiments, a LiDAR simultaneously emits at least two laser beams in different directions, and samples the echoes of these at least two laser beams through at least two receiving regions corresponding to each beam, where each receiving region includes at least one pixel. In an embodiment, the pixel data corresponding to the point cloud data in different receiving regions is also partitioned and stored in the cache region.

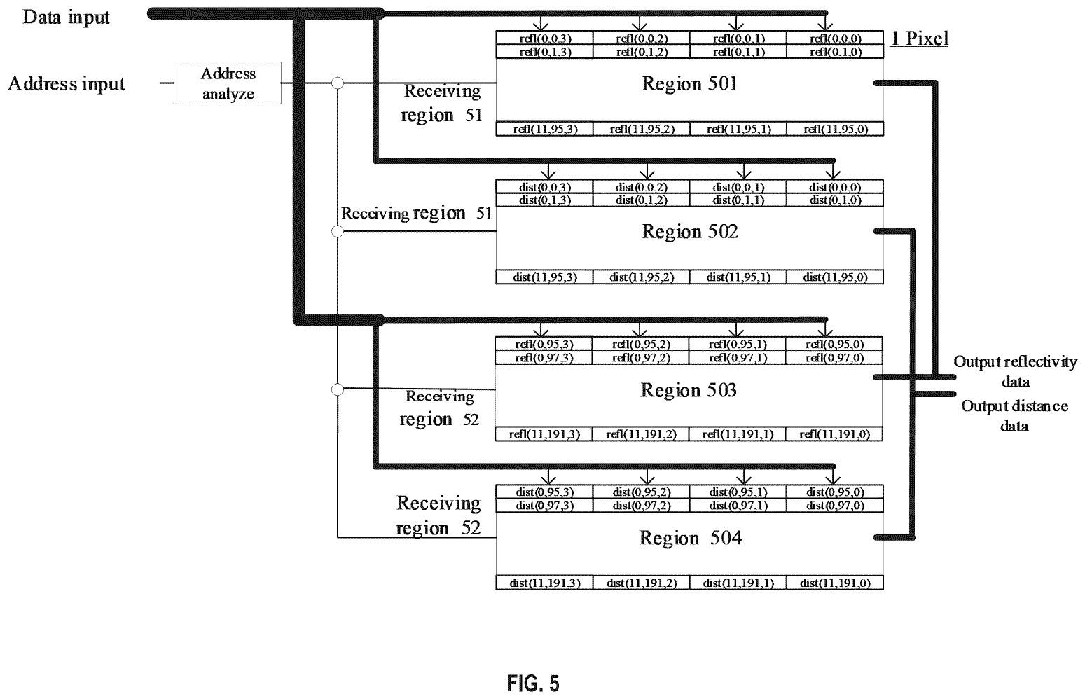

FIG. 5 illustrates a schematic diagram of storing the point cloud data in the cache region of the digital center module, according to some embodiments.

As shown in FIG. 5, the LiDAR simultaneously emits two laser beams in different directions and samples the echoes of the two laser beams through two corresponding receiving regions 51 and 52, each containing at least one pixel. The point cloud data corresponding to each pixel includes distance data and reflectivity data. In an embodiment, the cache of the digital center module is divided into four regions, including regions 501, 502, 503, and 504. Regions 501 and 503 are used to store the reflectivity data corresponding to the pixels in the two receiving regions 51 and 52, respectively. As shown in FIG. 5, ref (1, m, n) is used to represent the reflectivity data, where 1 and m represent the row and column where the reflectivity data is located, and n represents the data of the nth echo sampled by the pixel corresponding to the reflectivity data.

Region 502 and region 504 are used to store the distance data corresponding to the pixels in these two receiving regions. In each of the four regions in the cache region, the stored data is continuously stored in the order of the point cloud on the same row in one frame of point cloud data. As shown in FIG. 5, dist(l,m,n) is used to represent distance data, where 1 and m represent the row and column where the distance data corresponding to the pixel is located, and n represents the data of the nth echo sampled by the pixel corresponding to the distance data.

In an embodiment, before determining the module to be analyzed from the at least two intermediate processing modules, the cache of the digital center module is released and divided into at least two regions. When switching the digital center module to input the fetched data into the cache of the digital center module for storage in step S206, the fetched data is stored in at least two regions of the cache of the digital center module through a ping-pong operation. Each time the framing module reads the fetched data from the cache of the digital center module, the fetched data from the module to be analyzed can also be stored in the cache of the digital center module.

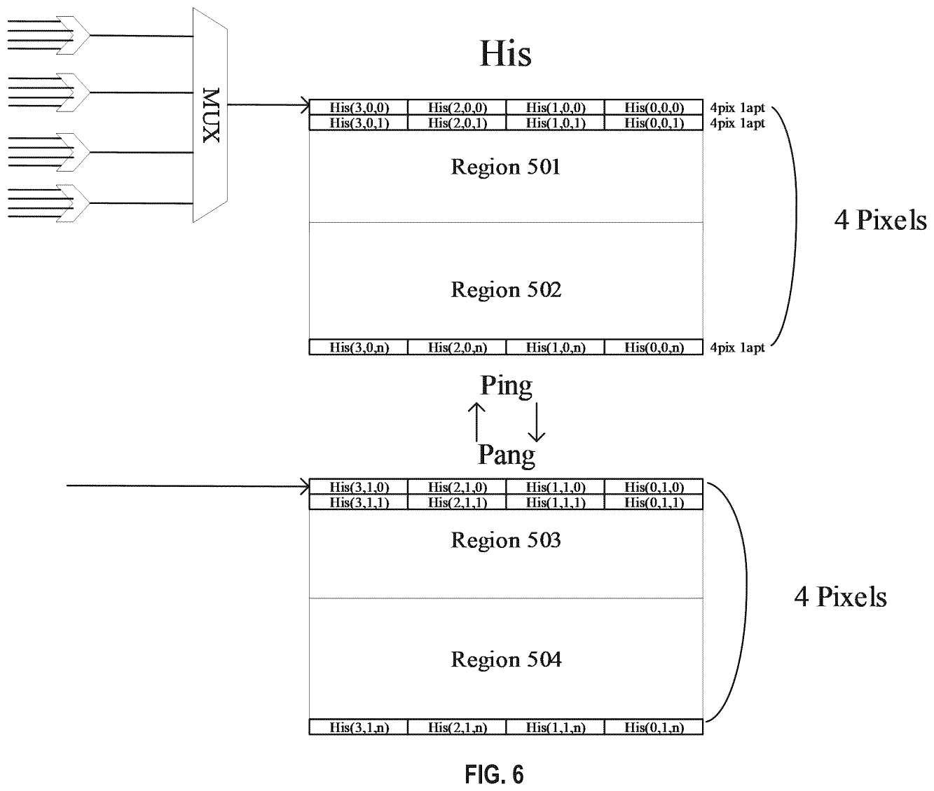

FIG. 6 illustrates a schematic diagram of storing the fetched data in the cache region of the digital center module through a ping-pong operation, according to some embodiments.

As shown in FIG. 6, referring to the cache region of the digital center module shown in FIG. 5, the cache region is divided into two regions, where region 501 and region 502 are grouped into one region, and region 503 and region 504 are grouped into one region. Taking the fetched data as histogram data, and taking the example of the cache region of the digital center module being capable of storing fetched data corresponding to pixel data of 4 pixels as an example, combined with the example shown in FIG. 4, when the framing module reads the fetched data corresponding to the 4 pixels of the first column 411's pixel data from the cache region of the digital center module, the fetched data corresponding to the 4 pixels of the second column 412's pixel data can also be stored in the cache region of the digital center module. The format of the stored data at each address in the cache region is as shown in FIG. 6, where His(l, m, n) represents the stored fetched data, l and m respectively indicate the row and column where the fetched data corresponds to the pixel, and n indicates the nth data in the pixel data corresponding to the fetched data.

In an embodiment, in step S203, when inputting the point cloud data into the cache of the digital center module for storage, the point cloud data corresponding to the sampling data obtained through the sampling module is sequentially stored in the cache of the digital center module in the order of sampling by the sampling module. Furthermore, the point cloud data on the same row in one frame of point cloud data is stored at adjacent storage addresses in the cache, allowing the framing module to read the point cloud data in the cache in a row-wise order. In this embodiment, the maximum pitch angle and the minimum pitch angle of the point cloud data on the same row in one frame of point cloud data differ by less than a first preset angle.

In some embodiments, although point cloud data is input into the cache region through the sampling order, the storage addresses of each point cloud point data may not be sequentially adjacent in output order. In an embodiment, the storage position of each point cloud point data is determined based on the position of each point cloud point in a frame of point cloud, so that the storage addresses of two adjacent point cloud point data in a frame of point cloud image are adjacent, allowing the framing module to read the point cloud data in the cache in row order.

In some embodiments, the LiDAR has a working mode and a detection mode. In the working mode, steps S202 to S204 are executed. In the detection mode, steps S205 to S207 are executed. The detection mode can be used to perform fault analysis on each intermediate processing module in the LiDAR before it leaves the factory, or it can be activated during operation after the LiDAR leaves the factory through passive triggering or active triggering to conduct fault analysis on each intermediate processing module in the LiDAR. In an embodiment, the LiDAR can run the detection mode at fixed preset intervals or at regular predetermined times after leaving the factory to check if any intermediate processing module is faulty. In an embodiment, the LiDAR can enter the detection mode upon receiving instructions from the user or other devices to check for faults in the intermediate processing modules. The LiDAR can monitor each frame of point cloud data in real-time, and when anomalies are detected in at least one frame of point cloud data, it can switch to the detection mode to check for faults in the intermediate processing modules.

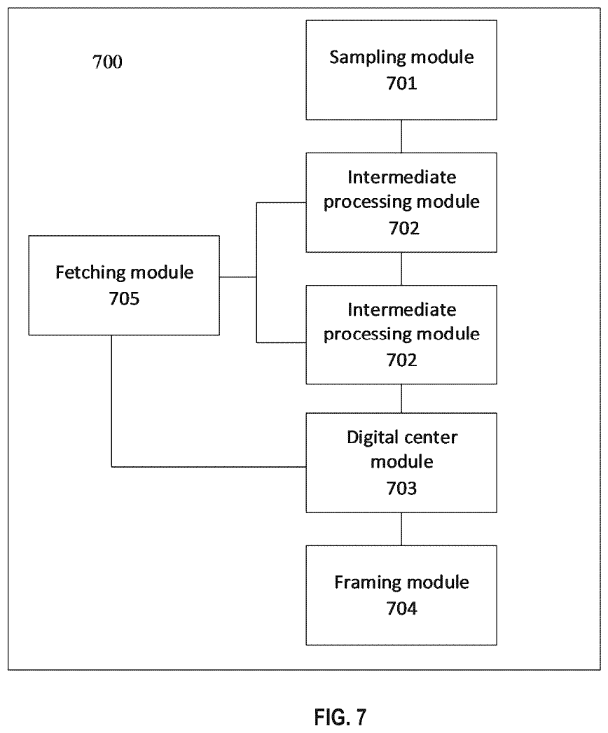

FIG. 7 illustrates a schematic diagram of a sampling data processing device, according to some embodiments.

In an embodiment, a sampling data processing device is provided. As shown in FIG. 7, the sampling data processing device 700 includes: a sampling module 701, at least two intermediate processing modules 702, a digital center module 703, a framing module 704, and a fetching module 705. The sampling module 701 is used to sample the echo to obtain sampling data.

The at least two intermediate processing modules are used to process the sampling data in sequence to obtain point cloud data. Each intermediate processing module processes the data from an upstream module to obtain intermediate data and then outputs it to a downstream module. The digital center module 703 is used to input the point cloud data into the cache of the digital center module 703 for storage. The framing module 704 is used to read the point cloud data from the cache region and generate at least one frame of point cloud data based on the point cloud data. The fetching module 705 is used to fetch data from the module to be analyzed when determined from the at least two intermediate processing modules 702, obtaining fetched data. The digital center module 703 is further used to switch to input the fetched data into a cache of the digital center module for storage. The framing module 704 is further used to read the fetched data from the cache region and perform fault analysis on the module to be analyzed based on the fetched data.

In an embodiment, when the module to be analyzed is determined from the at least two intermediate processing modules, the intermediate processing module downstream of the module to be analyzed also functions to enter a bypass mode, directly passing the fetched data to the digital center module through the intermediate processing module that enters the bypass mode.

In an embodiment, the at least two intermediate processing modules are connected to the digital center module through a group of buses respectively. The fetched data is inputted into the cache of the digital center module through a bus between the module to be analyzed and the digital center module.

In an embodiment, the LiDAR has a working mode and a detection mode. In the working mode, the method further includes processing the sampling data through the at least two intermediate processing modules in sequence, to obtain point cloud data, and inputting the point cloud data into a cache of the digital center module for storage. In the detection mode, the method executes determining the module to be analyzed from the at least two intermediate processing modules.

In an embodiment, the sampling module includes multiple pixels, and the sampling data includes pixel data obtained through at least some of the pixels for sampling. The device further includes: reading module, for when determining the module to be analyzed from the at least two intermediate processing modules, before fetching data from the module to be analyzed in the sampling module, pixel data in different regions of the sampling module is read in multiple times. The pixel data read in one time is processed by the module to be analyzed, and after the fetched data of the module to be analyzed is stored in the cache of the digital center module, the next reading cycle begins.

In an embodiment, when the fetched data corresponding to the pixel data read in one time is stored in the cache of the digital center module, the fetched data corresponding to the pixel data read in a last time is covered in the cache.

In an embodiment, when the digital center module inputs the point cloud data into the cache of the digital center module for storage, storing the point cloud data corresponding to the sampling data obtained in the sampling sequence of the sampling module into the cache of the digital center module in order.

The point cloud data on the same row in one frame of point cloud data is stored at adjacent storage addresses in the cache region, so that the framing module can read the point cloud data in the cache in an order of rows, where the maximum pitch angle and the minimum pitch angle of the point cloud data on the same row of one frame differ by less than a first preset angle.

In an embodiment, the point cloud data includes distance data and reflectivity data. The cache region of the digital center module partitions and stores the distance data and the reflectivity data separately, where the distance data on the same row in one frame of point cloud data is stored at adjacent storage addresses in the cache, and the reflectivity data on the same row in one frame of point cloud data is stored at adjacent storage addresses in the cache.

In an embodiment, before determining the module to be analyzed from the at least two intermediate processing modules, the cache of the digital center module is released and divided into at least two regions. The digital center module, when switching the digital center module to input the fetched data into a cache of the digital center module for storage, is used to store the fetched data in at least two regions of the cache of the digital center module through a ping-pong operation.

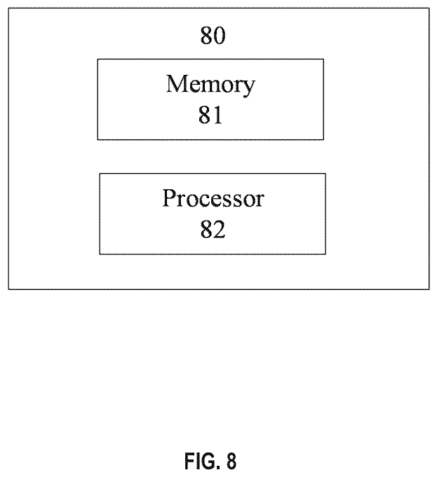

FIG. 8 illustrates a schematic diagram of the LiDAR, according to some embodiments.

In an embodiment, a LiDAR is provided, as shown in FIG. 8, the LiDAR 80 includes a memory 81 and a processor 82.

The processor 82 can be a Central Processing Unit (CPU), or other general processors, Digital Signal Processor (DSP), Application Specific Integrated Circuit (ASIC), Field-Programmable Gate Array (FPGA), or other programmable logic devices, discrete gates or transistor logic devices, discrete hardware components, etc. The general processor can be a microprocessor or any conventional processor.

The storage unit 81 can include various types of storage units, such as system memory, read-only memory (ROM), and permanent storage devices. ROM can store static data or instructions required by the processor 82 or other modules of the computer. The permanent storage device can be a writable storage device that retains instructions and data even when the computer is powered off, making it a non-volatile storage device. In some embodiments, large-capacity storage devices (such as magnetic or optical disks, flash memory) are used as permanent storage devices. In other embodiments, the permanent storage device can be a removable storage device (such as floppy disks, optical drives). System memory can be a writable or volatile writable storage device, such as dynamic random-access memory. System memory can store some or all of the instructions and data required by the processor during operation. Additionally, the storage unit 81 can include a combination of any computer-readable storage media, including various types of semiconductor storage chips (such as DRAM, SRAM, SDRAM, flash memory, programmable read-only memory), as well as disks and/or optical discs. In some embodiments, the storage unit 80 may include removable storage devices that are readable and/or writable, such as compact discs (CDs), read-only digital versatile discs (DVD-ROMs, dual-layer DVD-ROMs), read-only Blu-ray discs, high-density optical discs, flash memory cards (such as SD cards, miniSD cards, Micro-SD cards, etc.), magnetic floppy disks, and the like. Computer-readable storage media do not include carriers and instantaneous electronic signals transmitted wirelessly or wired.

The storage medium 81 stores executable code, and when the executable code is processed by processor 82, the processor 82 can execute some or all of the methods described above.

Some embodiments are implemented as a computer-readable storage medium (or non-transitory machine-readable storage medium or machine-readable storage medium) storing executable code (or computer program or computer instruction code), where when the executable code (or computer program or computer instruction code) is executed by a processor of an electronic device (or server, etc.).

What is claimed is:

1. A sampling data processing method for a LiDAR, wherein the LiDAR comprises a sampling module, at least two intermediate processing modules, a digital center module, and a framing module, and wherein the method comprises:
sampling an echo through the sampling module to obtain sampling data;
processing the sampling data through the at least two intermediate processing modules in sequence to obtain point cloud data, wherein each intermediate processing module performs data processing on data from an upstream module to obtain intermediate data and outputs the intermediate data to a downstream module;
inputting the point cloud data into a cache of the digital center module for storage;
reading the point cloud data from the cache through the framing module, and generating at least one frame of point cloud data based on the point cloud data;
when a module to be analyzed is determined from the at least two intermediate processing modules, fetching data from the module to be analyzed to obtain fetched data;
switching the digital center module to input the fetched data into a cache of the digital center module for storage; and
reading the fetched data from the cache through the framing module, and performing fault analysis on the module to be analyzed based on the fetched data.

2. The method according to claim 1, wherein when the module to be analyzed is determined from the at least two intermediate processing modules, the method further comprises:
controlling an intermediate processing module downstream of the module to be analyzed to enter a bypass mode; and
directly passing the fetched data to the digital center module through the intermediate processing module having entered the bypass mode.

3. The method according to claim 1, wherein the at least two intermediate processing modules are connected to the digital center module through a group of buses respectively; and
wherein the fetched data is inputted into the digital center module through a bus between the module to be analyzed and the digital center module.

4. The method according to claim 1, wherein the LiDAR has a working mode and a detection mode;
wherein in the working mode, the method further comprises processing the sampling data through the at least two intermediate processing modules in sequence, to obtain point cloud data, and inputting the point cloud data into a cache of the digital center module for storage; and
wherein in the detection mode, the method further comprises determining the module to be analyzed from the at least two intermediate processing modules.

5. The method according to claim 1, wherein the sampling module comprises a plurality of pixels, and the sampling data comprises pixel data obtained through at least some of the pixels for sampling; and
wherein when the module to be analyzed is determined from the at least two intermediate processing modules, before fetching the data from the module to be analyzed to obtain the fetched data, the method further comprises:
reading pixel data in different regions of the sampling module for a plurality of times, wherein the pixel data read in one time is processed by the module to be analyzed, and after the fetched data of the module to be analyzed is stored in the cache of the digital center module, a next reading starts.

6. The method according to claim 5, wherein when the fetched data corresponding to the pixel data read in the one time is stored in the cache of the digital center module, the fetched data corresponding to the pixel data read in a last time is covered in the cache.

7. The method according to claim 1, wherein the inputting the point cloud data into the cache of the digital center module for storage comprises:
sequentially storing point cloud data corresponding to the sampling data obtained by sampling through the sampling module in the cache of the digital center module in an order of sampling by the sampling module, wherein point cloud data on a same row in one frame of point cloud data is stored at adjacent storage addresses in the cache, so that the framing module can read the point cloud data in the cache in an order of rows, and
wherein a maximum pitch angle and a minimum pitch angle of point cloud data on the same row in the one frame of point cloud data differ by less than a first preset angle.

8. The method according to claim 7, wherein the point cloud data comprises distance data and reflectivity data;
wherein the cache of the digital center module partitions and stores the distance data and the reflectivity data separately; and
wherein the distance data on the same row in the one frame of point cloud data is stored at adjacent storage addresses in the cache, and the reflectivity data on the same row in the one frame of point cloud data is stored at adjacent storage addresses in the cache.

9. The method according to claim 1, wherein before the module to be analyzed is determined from the at least two intermediate processing modules, the cache of the digital center module is released and divided into at least two regions; and
wherein the switching the digital center module to input the fetched data into a cache of the digital center module for storage comprises:
storing the fetched data in at least two regions of the cache of the digital center module through a ping-pong operation.

10. A sampling data processing device, comprising a sampling module, at least two intermediate processing modules, a digital center module, a framing module, and a fetching module, wherein:
the sampling module is configured to sample an echo to obtain sampling data;
the at least two intermediate processing modules are configured to process the sampling data in sequence to obtain point cloud data, wherein each intermediate processing module is configured to perform data processing on data from an upstream module to obtain intermediate data and then output the intermediate data to a downstream module;
the digital center module is configured to input the point cloud data into a cache of the digital center module for storage;
the framing module is configured to read the point cloud data from the cache and generate at least one frame of point cloud data based on the point cloud data;
the fetching module is configured to, when the module to be analyzed is determined from the at least two intermediate processing modules, fetch data from the module to be analyzed to obtain fetched data;
the digital center module is further configured to switch to input the fetched data into a cache of the digital center module for storage; and
the framing module is further configured to read the fetched data from the cache and perform fault analysis on the module to be analyzed based on the fetched data.

11. A LiDAR, comprising:
a processor, and
a storage medium storing executable code, wherein when the executable code is executed by the processor, the processor performs the method according to claim 1.
